(19) United States
(12) Patent Application Publication
(10) Pub. No.: US 2011/0131320 A1
(43) Pub. Date: Jun. 2, 2011

(54) APPARATUS AND METHOD OF DYNAMICALLY MANAGING SENSOR MODULE ON SENSOR NODE IN WIRELESS SENSOR NETWORK

(75) Inventors: Sang-Gi Hong, Daejeon-City (KR); Sang-Joon Park, Daejeon-City (KR); Cheol-Sig Pyo, Daejeon-city (KR); Jong-Suk Chae, Daejeon-City (KR)

(73) Assignee: Electronics and Telecommunications Research Institute, Daejeon-city (KR)

(21) Appl. No.: 12/808,432

(22) PCT Filed: Nov. 17, 2008
(86) PCT No.: PCT/KR2008/006738

§ 371 Date: Jun. 16, 2010

(30) Foreign Application Priority Data
Dec. 17, 2007 (KR) 10-2007-0132597

(51) Int. Cl. G06F 15/173

(52) U.S. Cl. 709/224

(57) ABSTRACT

Provided is an apparatus and method of dynamically managing a sensor module on a sensor node in a wireless sensor network. The apparatus includes an update unit, a request unit, and a transmission unit. If a change occurs in sensor data corresponding to each sensor node stored in a sensor information storage server, the update unit receives the sensor data from the sensor information storage server, and transmits the received sensor data to the corresponding sensor node. The request unit requests the sensor data from the sensor information storage server upon receipt of a sensor data request message from the sensor node. The transmission unit receives the requested sensor data from the sensor information storage server and transmits the received sensor data to the sensor node.

### TECHNICAL FIELD

The present invention relates to dynamic management of sensor modules in a sensor network, and more particularly, to a system and method of supporting plug-and-play of sensor modules and dynamic correction of sensor data between sensor network components in a sensor network including different sensor modules provided by different companies.

The present invention is derived from a research project supported by the Information Technology (IT) Research & Development (R&D) program of the Ministry of Information and Communication (MIC) and the Institute for Information Technology Advancement (IITA) [2005-S-038-03, Development of UHF RF-ID and Ubiquitous Networking technologies].

### BACKGROUND ART

A wireless sensor network includes a plurality of sensor nodes. The sensor nodes each include a communication unit for performing radio frequency (RF) communication with an upper sink node, a management server or another sensor node, a sensor module for sensing and processing ambient information, a memory for storing correction information (algorithm) of data sensed by the sensor module or a driver of the sensor module, and a control unit for controlling them.

The sensor module is united with the sensor node. Alternatively, a plurality of additional sensor nodes is attachable/detachable to/from the sensor node. However, conventional sensor modules cannot provide a dynamic update technique in processing ambient information sensed on the basis of driver information or correction information.

### DISCLOSURE OF INVENTION

### Technical Problem

Thus, it is difficult to update/manage correction information or driver information of a plurality of different sensor modules in a wireless sensor network, which are provided by different companies.

### Technical Solution

The present invention provides a system and method of supporting plug-and-play of sensor modules and dynamic correction of sensor data between sensor network components in a sensor network including different sensor modules provided by different companies.

### Advantageous Effects

The present invention automatically updates the database of a computer connected to an on-line network to provide the dynamic manage of sensor modules for a sensor network service. Thus, it is possible to automatically manage the installation, addition, removal, and update of the sensor module driver and the sensor calibration and correction data.

### DESCRIPTION OF DRAWINGS

The above and other features and advantages of the present invention will become more apparent by describing in detail exemplary embodiments thereof with reference to the attached drawings in which:

FIG. 1 illustrates a system for dynamic management of sensor modules according to an embodiment of the present invention;

FIG. 2 is a flow diagram illustrating a process for dynamically receiving, if sensor data is not installed in a sensor node, the sensor data from a sensor information storage server according to an embodiment of the present invention;

FIG. 3 is a flow diagram illustrating a process for performing, if sensor data is installed in a sensor node, an update operation by checking whether the sensor data is an up-to-date version, according to an embodiment of the present invention;

FIG. 4 is a flow diagram illustrating a process for updating, if a sensor module provider generates up-to-date sensor data, the generated up-to-date sensor data in a sensor information storage server according to an embodiment of the present invention; and

FIG. 5 is a block diagram of a sensor node dynamic management apparatus according to an embodiment of the present invention.

### BEST MODE

The present invention provides a system and method of supporting plug-and-play of sensor modules and dynamic correction of sensor data between sensor network components (e.g., sensor modules, sensor nodes, gateways, a sensor network management server, a sensor data server, and a sensor module provider) in a sensor network including different sensor modules provided by different companies.

According to an aspect of the present invention, there is provided an apparatus for dynamically managing sensor nodes, the apparatus including: an update unit receiving, if a change occurs in sensor data corresponding to each sensor node stored in a sensor information storage server, the sensor data from the sensor information storage server, and transmitting the received sensor data to the corresponding sensor node; a request unit requesting the sensor data from the sensor information storage server upon receipt of a sensor data request message from the sensor node; and a transmission unit receiving the requested sensor data from the sensor information storage server and transmitting the received sensor data to the sensor node.

According to another aspect of the present invention, there is provided a method of dynamically managing sensor nodes in a sensor network system including a plurality of sensor nodes and a sensor information storage server, the method including: receiving, if a change occurs in sensor data corresponding to each sensor node stored in the sensor information storage server, the sensor data from the sensor information storage server, and transmitting the received sensor data to the corresponding sensor node; requesting the sensor data from the sensor information storage server upon receipt of a sensor data request message from the sensor node; and receiving the requested sensor data from the sensor information storage server and transmitting the received sensor data to the sensor node.

### MODE FOR INVENTION

The present invention will now be described more fully with reference to the accompanying drawings, in which exemplary embodiments of the invention are shown. Like reference numerals in the drawings denote like elements. The invention may, however, be embodied in many different forms and should not be construed as being limited to the embodiments set forth herein; rather, these embodiments are provided so that this disclosure will be thorough and complete, and will fully convey the concept of the invention to those skilled in the art.

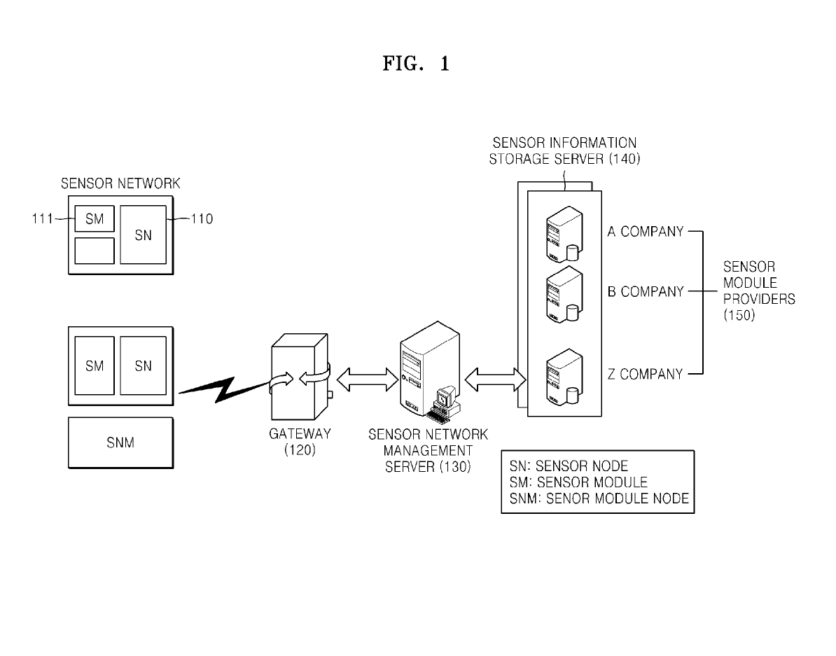

FIG. 1 illustrates a system for dynamic management of sensor modules according to an embodiment of the present invention.

Referring to FIG. 1, the system for dynamic management of sensor modules includes a sensor node 110, a sensor module 111, a gateway 120, a sensor network management server 130, and a sensor information storage server 140.

The sensor node 110 includes a communication unit, a sensor module, a memory, and a controller. The communication unit performs RF communication with an upper sink node, a management server or another sensor node. The sensor module senses/processes ambient information. The memory stores correction information (algorithm) of data sensed by the sensor module or a driver of the sensor module. The controller controls the communication unit, the sensor module, and the memory.

When the sensor module 111 is installed, it reads binary data sensor information, including information about sensor node connection interfaces, sensing information calibration and correction data, and the number, types and manufacturers of sensors in the sensor module to request the gateway 120, to install/update a sensor driver and sensor calibration and correction data. Also, the sensor module 111 installs driver data and calibration and correction data, which are downloaded from the gateway 120, in a memory of a sensor node so that the sensor module can operate smoothly.

The gateway 120 relays between the sensor node 110 of wireless environment and the sensor network management server 130 of wired environment. The gateway 120 converts a binary data request, which is received from the sensor node 110, into a message format such as XML, and transmits the resulting message to the sensor network management server 130. The gateway 120 transmits driver data and sensing calibration and correction data, which are received from the sensor network management server 130, to the sensor node 110.

The sensor network management server 130 performs the information management and the overall network management of the sensor network on the basis of information received from the gateway 120. The sensor network management server 130 interprets a message received from the gateway 120, extracts the prestored sensor driver and sensing information calibration and correction data from the sensor information storage server 140, and transmits the extracted data to the gateway 120.

The sensor information storage server 140 manages sensor drivers and sensing calibration and correction data, which are provided by sensor module providers 150 developing sensor modules, in a database fashion.

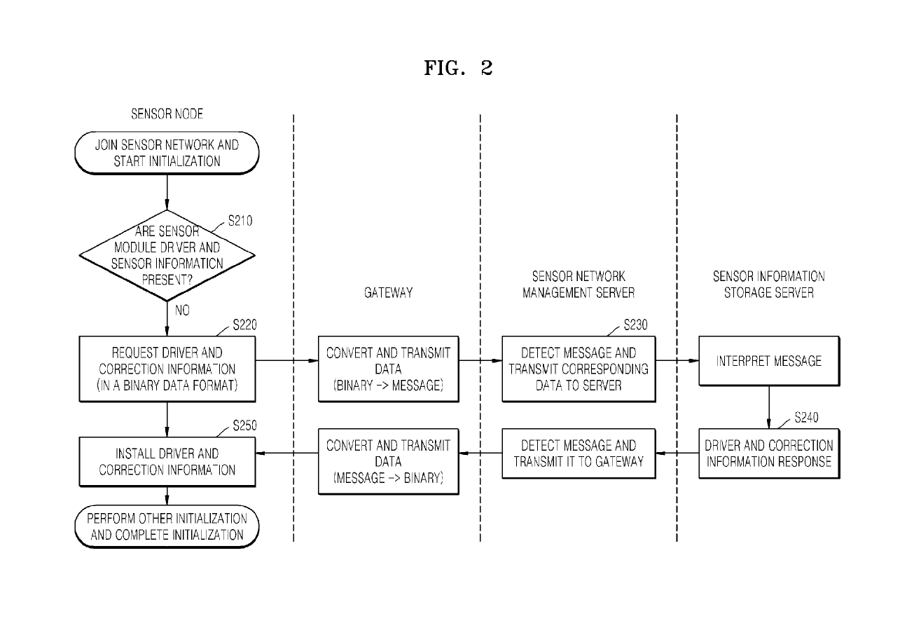

FIG. 2 is a flow diagram illustrating a process for dynamically receiving, if a sensor module driver and calibration and correction data are not installed in a sensor node, the sensor module driver and the calibration and correction data from a sensor information storage server according to an embodiment of the present invention.

Referring to FIG. 2, when a sensor node initially joins a network, the sensor node checks whether sensor data information including a sensor module driver and sensor correction information is present for initialization of the sensor node (S210). If the sensor module driver and the sensor correction information are not present, the sensor node requests the sensor module driver and the sensor correction information from a sensor network management server 130 (S220).

In this case, a sensor data request message for requesting the sensor module driver and the sensor correction information is transmitted through the gateway 120 to the sensor network management server 130.

The sensor network management server 130 transmits the sensor data request message for requesting the sensor module driver and the sensor correction information to a sensor information storage server 140 corresponding to the sensor node (S230). Based on the sensor data request message, the sensor information storage server 140 transmits a sensor data message including the corresponding driver and correction information to the sensor network management server 130 (S240).

The sensor network management server 130 detects the sensor data message, converts the sensor data message into a binary data format through a gateway, and transmits the resulting message to the sensor node. The sensor node installs the driver and correction information based on the received sensor data message (S250) and completes the initialization of the sensor node.

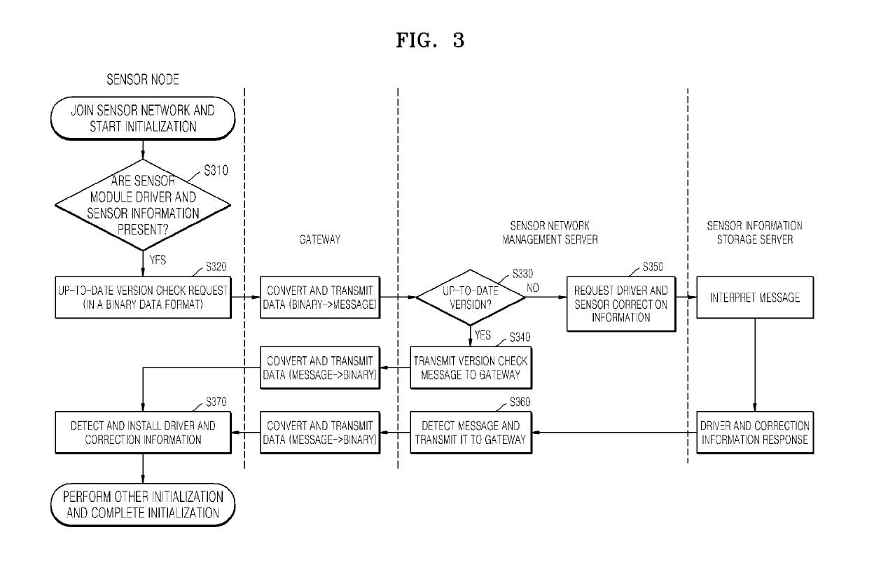

FIG. 3 is a flow diagram illustrating a process for performing, if sensor data is installed in a sensor node, an update operation by checking whether the sensor data is an up-to-date version, according to an embodiment of the present invention.

Referring to FIG. 3, when a sensor node initially joins a network, the sensor node checks whether sensor data including a sensor module driver and sensor correction information is stored in a memory of the sensor node for initialization of the sensor node (S310).

If the sensor data is stored in the memory, the sensor node transmits a sensor data request message for checking whether the sensor data is an up-to-date version to a sensor network management server 130. Upon receipt of the sensor data request message, the sensor network management server 130 transmits a message for indicating that the sensor data is an up-to-date version to the sensor node, if the sensor data is an up-to-date version (S340).

If the sensor data is not an up-to-date version, the sensor network management server 130 requests the up-to-data sensor data from a sensor information storage server 140 storing sensor data corresponding to each sensor node (S350). Upon receipt of the request from the sensor network management server 130, the sensor information storage server 140 transmits the corresponding sensor data to the sensor network management server 130 (S370). The sensor network management server 130 transmits the sensor data through a gateway to the sensor node. Then, the sensor node installs the up-to-date sensor data (S370).

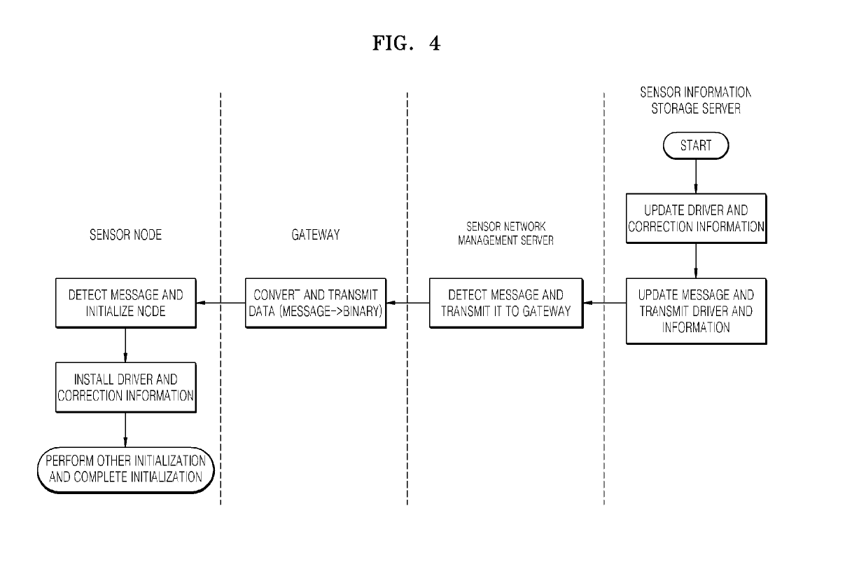

FIG. 4 is a flow diagram illustrating a process for updating, if a sensor module provider generates up-to-date sensor data, the generated up-to-date sensor data in a sensor information storage server according to an embodiment of the present invention.

Referring to FIG. 4, if a change occurs in the sensor module driver and correction information in the sensor information storage server, a sensor network management server transmits the changed sensor data to a sensor node.

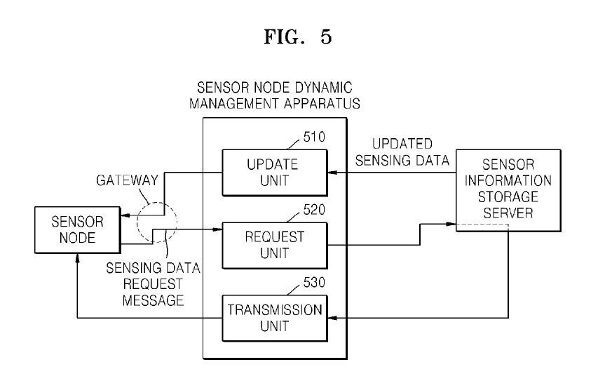

FIG. 5 is a block diagram of a sensor node dynamic management apparatus according to an embodiment of the present invention.

Referring to FIG. 5, the sensor node dynamic management apparatus includes an update unit 510, a request unit 520, and a transmission unit 530.

The update unit 510 receives up-to-date sensor data from a sensor information storage server storing sensor data corresponding to each sensor node. That is, as illustrated in FIG. 4, when a change occurs in the sensor module driver and correction information in the sensor information storage server, the update unit 510 receives the up-to-date sensor data from the sensor information storage server and transmits the received sensor data to the corresponding sensor node.

As illustrated with reference to FIGS. 2 and 3, when a sensor node joins a sensor network for initialization, the request unit 520 receives a sensor data request message from the sensor node and requests the sensor data from the sensor information storage server.

In this case, if the corresponding sensor data is not present in the sensor node when the sensor node initially joins the sensor network for initialization, the request unit 520 requests the sensor data corresponding to the sensor node.

On the other hand, if the corresponding sensor data is present in the sensor node when the sensor node initially joins the sensor network for initialization, it is checked whether the sensor data is an up-to-date version.

The transmission unit 530 receives the sensor data requested by the request unit 520 from the sensor information storage server, and transmits the received sensor data to the corresponding sensor node.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. For example, the computer readable recording medium can be distributed, stored and executed in embedded systems connected through a wireless network, such as sensor networks.

As described above, the present invention makes it possible to automatically manage the driver when the sensor node is attached or detached. The present invention automatically updates the database of a computer connected to an on-line network to provide the dynamic manage of sensor modules for a sensor network service. Thus, it is possible to automatically manage the installation, addition, removal, and update of the sensor module driver and the sensor calibration and correction data.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An apparatus for dynamically managing sensor nodes, the apparatus comprising:
an update unit receiving, if a change occurs in sensor data corresponding to each sensor node stored in a sensor information storage server, the sensor data from the sensor information storage server, and transmitting the received sensor data to the corresponding sensor node;
a request unit requesting the sensor data from the sensor information storage server upon receipt of a sensor data request message from the sensor node; and
a transmission unit receiving the requested sensor data from the sensor information storage server and transmitting the received sensor data to the sensor node.

2. The apparatus of claim 1, wherein the sensor data comprises sensor correction information and driver information of a sensor module.

3. The apparatus of claim 1, wherein the sensor data request message is transmitted to request sensor data corresponding to the sensor node if the corresponding sensor data is not present in the sensor node when the sensor node initially joins a sensor network for initialization.

4. The apparatus of claim 1, wherein the sensor data request message is transmitted to check whether the sensor data is an up-to-date version, if the corresponding sensor data is present in the sensor node when the sensor node initially joins a sensor network for initialization.

5. The apparatus of claim 1, wherein the sensor node transmits the sensor data request message after automatically reading the sensor data from a sensor module when joining a sensor network.

6. The apparatus of claim 1, wherein the communication with the sensor node is wireless communication thorough gateway through gateway and the communication with the sensor information storage server is wired communication.

7. A method of dynamically managing sensor nodes in a sensor network system including a plurality of sensor nodes and a sensor information storage server, the method comprising:
receiving, if a change occurs in sensor data corresponding to each sensor node stored in the sensor information storage server, the sensor data from the sensor information storage server, and transmitting the received sensor data to the corresponding sensor node;
requesting the sensor data from the sensor information storage server upon receipt of a sensor data request message from the sensor node; and
receiving the requested sensor data from the sensor information storage server and transmitting the received sensor data to the sensor node.

8. The method of claim 7, wherein the sensor data comprises sensor correction information and driver information of a sensor module.

9. The method of claim 7, wherein the sensor data request message is transmitted to request sensor data corresponding to the sensor node if the corresponding sensor data is not present in the sensor node when the sensor node initially joins a sensor network for initialization.

10. The method of claim 7, wherein the sensor data request message is transmitted to check whether the sensor data is an up-to-date version, if the corresponding sensor data is present in the sensor node when the sensor node initially joins a sensor network for initialization.
